(19) United States
(12) Patent Application Publication
(10) Pub. No.: US 2006/0251213 A1
(43) Pub. Date: Nov. 9, 2006

(54) Method for presetting the imaging parameters during the generation of two-dimensional fluoroscopic x-ray images

(75) Inventors: Philipp Bernhardt, Forchheim (DE); Marcus Pfister, Bubenreuth (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/429,139

(22) Filed: May 5, 2006

(30) Foreign Application Priority Data
May 6, 2005 (DE) 10 2005 021 068.6

(51) Int. Cl. G01N 23/04

(52) U.S. Cl. 378/62

(57) ABSTRACT

The invention relates to a method for presetting the imaging parameters during the generation of two-dimensional fluoroscopic x-ray images of a patient, wherein the optimally necessary dose for the fluoroscopic x-ray image is determined with the aid of a 3D representation, already present from prior examinations, of the internal structure of the patient and the intended imaging direction and this dose is used for the exposure of the fluoroscopic image.

### CROSS REFERENCE TO RELATED APPLICATIONS

This application claims priority of German application No. 102005021068.6 filed May 6, 2005, which is incorporated by reference herein in its entirety.

### FIELD OF THE INVENTION

The invention relates to a method for presetting the imaging parameters during the generation of two-dimensional fluoroscopic x-ray images of a patient.

### BACKGROUND OF THE INVENTION

It is generally known that in order to achieve an optimal image quality during the production of x-ray images the imaging parameters used, such as tube voltage, tube current, exposure time, pre-filtering, and hence the applied dose, have a major influence. In medical diagnostics there is also the problem that in order to avoid exposing the patient to unnecessary radiation as small a radiation dose as possible should be used, while at the same time it is necessary to produce images that facilitate the diagnosis. This is made more difficult still as a result of the variability of the patients in terms of their body mass and the different perspective in which the images are produced.

A recent trend is to use mostly digital detectors in x-ray systems instead of the usual films or image intensifiers. With such detectors an attempt is sometimes made to keep an abstract measure of image quality, for example the “contrast to noise” ratio or the system dose at the detector, constantly at a predetermined value via a control mechanism by adjusting the different imaging parameters, such as the voltage, the exposure time or the filters used. This is achieved essentially by tapping the parameters at a parameter set specific to the device, in which case, however, there is also the problem here that the starting parameters for the illumination from different directions have to be re-estimated each time by means of an initial measurement, with no sufficiently reliable indicators for the starting parameters being available for this initial measurement.

It is known to arrive at a reasonably accurate estimate by determining image quality criteria for a device as a function of the imaging parameters, such as voltage, exposure time and filters, with the aid of phantom measurements or simulation calculations using a phantom and subsequently solving the inverse problem by reversing the function thus determined in operation. In other words, a search is made for the corresponding parameter set that is suitable for a specific predefined measure of image quality with the aid of a specific function or predefined tables. With regard to this approach, reference is made to U.S. Pat. No. 6,222,907 B 1 and U.S. Pat. No. 6,233,310 B1.

However, all the aforementioned methods are based on the assumption of specific phantom values in respect of size and absorption behavior and can therefore return only approximation values for the measurement that is actually to be performed later.

### SUMMARY OF THE INVENTION

It is therefore the object of the invention to discover a method for presetting the imaging parameters during the generation of two-dimensional fluoroscopic x-ray images of a patient by means of which a maximum dose is achieved with a predefined image quality.

This object is achieved by the features of the independent claims. Advantageous developments of the invention are the subject matter of subordinate claims.

The inventors have recognized that a presetting of the imaging parameters can be carried out with greater accuracy compared with the known methods if existing volume data sets, such as are available from computed tomography examinations or magnetic resonance imaging examinations relating to a patient, and on the basis of this known volume data of the patient the actual absorption of the patient in the perspective currently used for generating a fluoroscopic image is used in order to determine herefrom the maximum dose necessary for generating a fluoroscopic x-ray image. In this case, for example, existing computed tomography volume data in which the absorption values are directly available can be used or the absorption values of the measured structure can be deduced from existing magnetic resonance images and in this way fluoroscopic images can be simulated or computed, with the result that an accurate presetting of the necessary parameters for executing the fluoroscopic image is possible.

In accordance with the above described basic idea the inventors propose a method for presetting the imaging parameters, such as tube voltage, tube current, exposure time and pre-filtering, during the generation of two-dimensional fluoroscopic x-ray images of a patient, wherein the actual absorption of the radiation by the patient in the perspective currently used for producing a fluoroscopic image is calculated with the aid of a 3D representation, already present from prior examinations, of the internal structure of the patient and the intended imaging direction in order to be able to determine the optimal imaging parameters and hence the maximum necessary dose for the fluoroscopic x-ray image and to use these imaging parameters for the exposure of the fluoroscopic image.

For this purpose existing 3D representations of a CT examination can be used, for example. In this case the x-ray absorption values corresponding to the CT representation, specified in HU units, can be taken over directly here.

If the CT representation was recorded using a different energy spectrum from that which is available for recording the fluoroscopic x-ray image, then the absorption values from the energy spectrum of the CT image generation can be converted to the energy spectrum of the fluoroscopic x-ray image, in which case empirical data, for example in the form of a table, can be used here for the conversion.

A further possibility consists in the use of the three-dimensional representation of an NMR image (i.e. the image of a magnetic resonance tomograph), in which case it is necessary here to convert the values recorded in the magnetic resonance tomogram to corresponding x-ray absorption values.

A conversion of this kind can be performed, for example, by segmenting at least two different tissue types, assigning a typical x-ray absorption value to each tissue type, and calculating the optimal imaging parameters using the three-dimensional distribution of the x-ray absorption values resulting therefrom.

Bone tissue and soft tissue, for example, can be segmented as the different tissue types, although it is also possible to perform a further differentiated distinction.

In addition it is also possible to take into account the spectrum used for the fluoroscopic image and to apply the x-ray absorption values of the respective tissue type as a function of this spectrum.

In order to discover the optimal imaging parameters, all the beam paths used can be calculated from a focus through a 3D representation of the patient to a two-dimensional detector with regard to their absorption, the optimal imaging parameters subsequently being determined on the basis of the average dose incident on the detector or the optimal imaging parameters being determined on the basis of the bandwidth of the doses of all beam paths incident on the detector. In this case the characteristics of the respective detector system can be taken into account.

In a special embodiment of the method according to the invention the inventors also propose, with regard to the optimal imaging parameters, using only the absorption values of a predetermined region of the patient. This is of interest in particular when, for example, a specific organ is to be assessed and the adjacent soft tissue or bone regions are not relevant to the diagnosis, with the result that the optimization can be geared solely to a particular organ or in the other instance to particular bone structures.

The optimal imaging parameters can differ according to the different detectors used, such as, for example, an x-ray film, an image intensifier or a digital detector. In this case particular account must be taken of the different dynamics of the detectors.

According to the invention the method can also be used in conjunction with the fluoroscopic images of a C-arm x-ray system, in which case it should be pointed out that three-dimensional representations originally generated by the C-arm device can also be used subsequently for the calculation of the fluoroscopic image.

In accordance with the above described basic idea of the invention the inventors also propose an x-ray device for generating fluoroscopic images of a patient, comprising a radiation source, at least one detector for detecting a fluoroscopic image, and a radiation parameter setting apparatus, which device is improved to the extent that a memory for recording 3D data sets of a patient is provided, a computer program for the virtual alignment of the 3D data sets in relation to radiation source and detector and a computer program for simulating or calculating the change in intensity of a radiation starting from the radiation source to the detector and for determining radiation parameters incident at the detector are present, whereby a control mechanism exists which adjusts the radiation source in terms of its radiation parameters on the basis of the data thus acquired such that predefined image quality features are maintained at the detector during the fluoroscopic imaging.

According to the invention a computer program which performs the above described method should also be stored in an x-ray device of this type or in another similar x-ray device or be executed during operation. It should be noted that the x-ray device according to the invention can be either a simple stationary fluoroscopic device or an x-ray device that is rotatable about a system axis in operation, corresponding to a C-arm device.

Additional features and advantages of the invention will emerge from the following description of preferred exemplary embodiments with reference to the drawings, with only the features necessary to an understanding of the invention being presented.

### BRIEF DESCRIPTION OF THE DRAWINGS

The invention is to be explained in more detail below with reference to the drawings, in which the following reference numerals are used: 1: bone tissue; 2: soft tissue; 3: focus; 4: detector; 5: irradiated volume.

Specifically, the drawings show:

FIG. 1: volume representation of a CT data set of the head of a patient;

FIG. 2: volume data set of the head of a patient from a magnetic resonance image; and

FIG. 3: a schematic representation of a simulated fluoroscopic image based on a three-dimensional absorption data set.

### DETAILED DESCRIPTION OF THE INVENTION

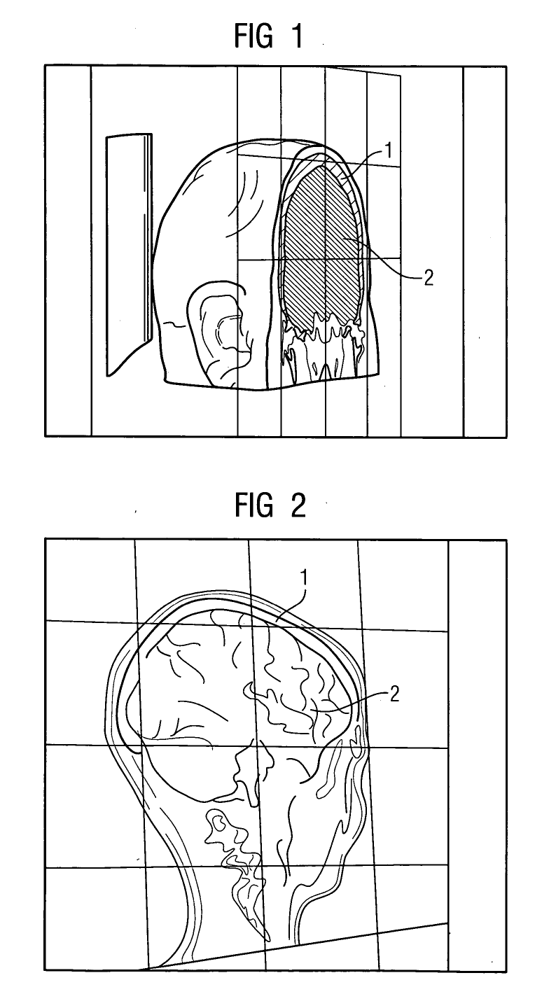

FIG. 1 shows by way of example a three-dimensional data set of the absorption values, determined by a computer tomograph, of a head of a patient. In this figure, basically two different tissue types, namely bone tissue 1 and soft tissue 2, with widely dissimilar absorption values can be recognized. The distribution of the absorption values shown therein in the three-dimensional space can be used according to the invention to simulate virtually the beam paths during the production of a fluoroscopic x-ray image and to simulate the generated dose on a two-dimensional detector.

Similarly, FIG. 2 shows a three-dimensional data set of a magnetic resonance image which, however, contains a more pronounced structure in the area of the tissue. Nonetheless, the structure shown there does not correspond directly to the x-ray absorption values, but according to the invention must first be converted to x-ray absorption values. This can be done, for example, by filling structures clearly recognizable as bone areas 1 with the x-ray absorption values known per se and the remaining soft tissue areas 2 with the corresponding x-ray absorption values for soft tissue. As a result of the three-dimensional structure of the absorption values then obtained it is similarly possible, as with x-ray CT data, to generate a virtual x-ray fluoroscopic image, whereby any desired perspective, in accordance with the perspectives actually present later, can be selected.

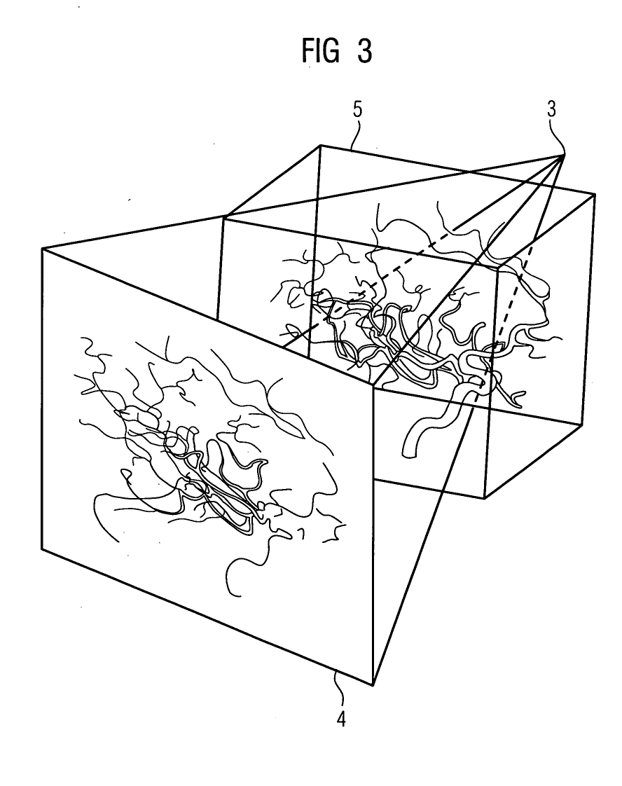

FIG. 3 schematically shows the implementation of a virtual fluoroscopic image of this kind, with the beam paths having their origin in a focus 3 and being guided to a detector 4. All the absorption values along the beam paths are known, so that, starting from an input intensity of the radiation, after the beams have passed through the volume 5 under investigation and strike the opposite detector 4, the intensity incident thereon can be calculated. By this means it is therefore possible, depending on the chosen imaging parameters, to simulate or explicitly calculate which dose values arrive at the detector 4 and to determine the setting of the output parameters that is suitable for the detector in each case at the focus 3, so that on the one hand the patient is exposed to a minimum dose and on the other hand the desired dose quantity for generating an optimal image arrives on the detector side. In addition to the integral or average dose across the detector, the dose distribution on the detector can also be taken into account, thus ensuring that an optimal image quality or, as the case may be, an adequate image quality corresponding to the parameters is achieved while at the same time a minimum radiation dose is used.

In addition, when taking into account the energy spectrum used, or more precisely when varying the energy spectrum used, it can be ensured that an acceleration voltage is chosen which is just sufficient to make a desired signal-to-noise ratio or a desired structuring in the representation of tissue recognizable, while on the other hand the x-ray energy is not chosen to be lower than is absolutely necessary, since irreparable damage in the tissue can increasingly result as the radiation energy becomes lower. It is therefore possible in this way to pre-calculate a very specific presetting for the ultimate execution of a fluoroscopic image and at the same time minimize the patient's exposure to radiation.

To round off, it should also be pointed out that this method can also be performed in conjunction with continuous images from different perspectives, such as are taken, for example, in the case of C-arm images. In particular the described method can also be used in conjunction with contrast agents, as used in angiography.

It goes without saying that the above cited features of the invention can be used not only in the combination specified in each case, but also in other combinations or in isolation, without departing from the scope of the invention.

1-18. (canceled)

19. A method for presetting an imaging parameter during a generation of a two-dimensional fluoroscopic x-ray image, comprising:
providing an existing 3D representation from a prior examination of a patient;
calculating an x-ray absorption value for the generation of the fluoroscopic x-ray image of an internal structure of the patient and an intended imaging direction based on the existing 3D representation;
determining the imaging parameter for a lowest radiation dose exposure to the patient; and
using the imaging parameter for the generation of the fluoroscopic x-ray image of the patient.

20. The method as claimed in claim 19, wherein a CT representation is used as the existing 3D representation.

21. The method as claimed in claim 20, wherein an x-ray absorption value used in a fluoroscopic x-ray image is taken directly from the CT representation.

22. The method as claimed in claim 20, wherein an x-ray absorption value used in the CT representation is converted to an x-ray absorption value used in a fluoroscopic x-ray image if an energy spectrum used in the CT representation is different than an energy spectrum used in the fluoroscopic x-ray image.

23. The method as claimed in claim 22, wherein the conversion is performed using a table of empirical data.

24. The method as claimed in claim 19, wherein an NMR representation is used as the existing 3D representation.

25. The method as claimed in claim 24, wherein a plurality of different patient tissue types are segmented from the NMR representation and an x-ray absorption value is assigned to each of the tissue types, and an imaging parameter is calculated based on a 3D distribution of the x-ray absorption value.

26. The method as claimed in claim 25, wherein the different tissue types are segmented as a bone tissue and a soft tissue.

27. The method as claimed in claim 25, wherein an x-ray absorption value of the different tissue types is a function of an energy spectrum of a fluoroscopic x-ray image.

28. The method as claimed in claim 19, wherein a beam path that is transmitted from a focus point through the existing 3D representation of the patient to a two-dimensional detector is calculated.

29. The method as claimed in claim 28, wherein the imaging parameter is determined based on an average dose on the two-dimensional detector.

30. The method as claimed in claim 28, wherein the imaging parameter is determined based on a bandwidth of doses of all beam paths on the two-dimensional detector.

31. The method as claimed in claim 28, wherein only the x-ray absorption value of a predetermined region of the patient is used in determining the imaging parameter.

32. The method as claimed in claim 19, wherein a detector used in the generation of the fluoroscopic x-ray image is selected from the group consisting of: x-ray film, image intensifier, and digital detector.

33. The method as claimed in claim 19, wherein the imaging parameter is selected from the group consisting of: tube voltage, tube current, exposure time, and pre-filtering.

34. The method as claimed in claim 19, wherein the method is used for generating a fluoroscopic x-ray image of a C-arm x-ray system.

35. An x-ray device for generating a fluoroscopic x-ray image of a patient, comprising:
a radiation source;
a detector for detecting the fluoroscopic x-ray image;
a radiation parameter setting device;
a memory for recording 3D data sets of the patient;
an alignment device for virtual aligning the 3D data sets in relation to the radiation source and the detector;
a simulator for simulating a change of a radiation intensity from the radiation source to the detector; and
a radiation parameter determining device for determining a radiation parameter at the detector,
wherein the radiation source is adjusted based on the radiation parameter at the detector so that a predefined image quality is maintained at the detector during the generating of the fluoroscopic x-ray image of the patient.

36. The x-ray device as claimed in claim 35, wherein the x-ray device is a stationary fluoroscopic x-ray device.

37. The x-ray device as claimed in claim 35, wherein the x-ray device is a rotatable fluoroscopic x-ray device.

38. A computer program for determining a radiation parameter at a detector when generating a fluoroscopic x-ray image of a patient, comprising:
a memory for recording 3D data sets of the patient;
a computer sub program for virtual aligning the 3D data sets in relation to a radiation source and the detector;
a computer sub program for simulating a change of a radiation intensity from the radiation source to the detector; and
a computer sub program for determining the radiation parameters at the detector in the generation of the fluoroscopic x-ray image of the patient.
